(19) United States
(12) Patent Application Publication
(10) Pub. No.: US 2020/0108397 A1
(43) Pub. Date: Apr. 9, 2020

(54) TUBE PICKING MECHANISM WITH UNIVERSAL PICKING HEAD AND CACHE

(71) Applicant: Hamilton Storage Technologies, Inc., Franklin, MA (US)

(72) Inventor: Gordon Andrade, Douglas, MA (US)

(73) Assignee: Hamilton Storage Technologies, Inc., Franklin, MA (US)

(21) Appl. No.: 16/574,136

(22) Filed: Sep. 18, 2019

Related U.S. Application Data
(60) Provisional application No. 62/741,053, filed on Oct. 4, 2018.

(51) Int. Cl. B01L 7/00

(52) U.S. Cl. CPC B01L 7/50; B01L 2200/16; B01L 2300/0609; B01L 2300/06; B01L 2300/0809; B01L 2300/021

(57) ABSTRACT

A tube picking mechanism is suitable for use in an automated, ultra-low temperature (e.g., −80° C.) storage and retrieval systems which stores biological or chemical samples. The samples are contained in storage tubes held in SBS footprint storage racks that are loaded into trays located within an ultra-low temperature freezer compartment (−80° C.). The tube picking mechanism includes a picking head and a cache that can accommodate sample tubes and vials of different sizes and diameters

### FIELD OF THE INVENTION

The invention is directed to features of a tube picking mechanism that is particularly well suited for use in a robotic, ultra-low temperature sample storage and retrieval system. The invention enables sample tubes of different diameters to be conveniently stored in tube racks and robotically retrieved from the freezer.

### BACKGROUND OF THE INVENTION

The assignee of the present application owns U.S. Pat. No. 7,861,540 by Robert P. Cloutier et al., issuing on Jan. 4, 2011 and entitled “Automated Storage and Retrieval System for Storing Biological or Chemical Samples at Ultra-Low Temperatures”; and U.S. Pat. No. 8,176,747 by Howard et al., issuing on May 15, 2012 and entitled “Tube Picking Mechanism for an Automated, Ultra-low Temperature Storage and Retrieval System” both of which are hereby incorporated by reference. These patents describe an automated, ultra-low temperature sample storage and retrieval system having freezer racks mounted within an insulated, ultra-low temperature freezer compartment (−80° C.). The freezer racks include trays or shelves for storing sample storage containers, which are typically tube storage racks holding an array of sample tubes. A mechanical robot is provided within the ultra-low temperature storage compartment to place the tube storage racks in an appropriate tray on the freezer rack and to retrieve the tube storage racks. The tube storage racks are typically SBS footprint compatible. The system is capable of storing other types of other SBS-formatted containers, such as microtiter plates or reservoirs, but typically these systems are used to store samples in capped sample tubes held in tube storage racks. The robot communicates with an access module in order to introduce tube storage racks into the system and retrieve tube storage racks for use outside of the system. The freezer racks have a capacity of several hundred or more tube storage racks. The present invention is directed to a tube picking apparatus that is particularly well suited for use in the automated ultra-low temperature storage and retrieval system disclosed in the above incorporated patent application, but also may be useful in other systems as well.

As explained in the above incorporated patents, biological samples stored in ultra-low temperature systems are often contained in sealed plastic laboratory tubes or vials having a diameter of 8 mm or larger. Larger tubes are sometimes called vials in the art, but both are referred herein as tubes or storage tubes. In any event, the tubes or vials are typically held in tube storage racks in arrays of, for example, 96, 48 or 24 tubes. The tube racks, as mentioned, typically have SBS footprint compatible dimensions. In some cases, a two-dimensional bar code containing identifying information is adhered to the bottom of the storage tubes and is able to be read through openings in the bottom of the SBS tube storage racks. It is known to use a two-dimensional bar code reader, e.g. at the access module, to track the samples tubes as they are placed in to the system and retrieved from the system. In some cases, a one-dimensional bar code containing identifying information is placed on the sidewall of the storage tube.

As explained in the above incorporated patents, it is not normally desirable to remove an entire SBS tube storage rack from the system when only one or a few sample tubes from a given rack are desired to be retrieved. The removal procedure allows for the ingress of moisture into the ultra-low temperature storage compartment which leads to frost build up, and also renders the other samples held in the same SBS tube rack susceptible to thawing, at least partially, even if the tube rack is removed from the system temporarily.

In order to address these issues, the above incorporated patents disclose the use of a tube picking chamber adjacent the freezer compartment, preferably incorporated into the insulated freezer door. A retractable shuttle door is located between the tube picking chamber and the ultra-low temperature storage compartment. A reach arm for the robot within the ultra-low temperature freezer compartment supplies a selected SBS tube rack (i.e., a source rack) to a specific location in freezer compartment that can also be accessed by a robotic shuttle constituting part of the tube picking mechanism. Picked tubes are loaded into another tube rack (i.e., a destination rack) that is intended to exit the system. The shuttle door for the tube picking chamber normally remains closed, isolating the tube picking chamber from the ultra-low temperature freezer compartment under normal storage conditions. When use of the tube picking mechanism is requested, dry gas is introduced into the tube picking chamber with the shuttle door closed in order to reduce the relative humidity within the chamber. A relative humidity sensor is located within the tube picking chamber for this purpose. When the relative humidity has been lowered to the desirable level, for example less than 2% relative humidity, the shuttle door is opened and cold air from the ultra-low temperature freezer compartment is allowed to flow into the tube picking chamber. A temperature sensor is also located in the tube picking chamber. The shuttle door is opened and closed as necessary to maintain the temperature in the tube picking chamber at a freezing temperature that is above the ultra-low temperature (−80° C.) in the storage compartment, preferably −5° C. to −25° C., e.g. about −20° C. In this manner, the tube picking mechanism, and its mechanical and electrical components, can operate in a less harsh environment which greatly improves reliability. On the other hand, by maintaining the tube picking chamber at a subfreezing temperature, the other samples in the pertinent source racks need not exit the system in order to retrieve the desired storage tube or tubes. This not only protects the other samples from premature thaw and harm, but also reduces the risk of moisture flow into the ultra-low temperature freezer compartment. Further, because the relative humidity is maintained at a low level within the tube picking compartment, tube racks can be shuttled in and out of the tube picking compartment at a relatively fast pace compared to shuttling through the main access module. Fast pace shuttling shortens exposure time outside of the −80° environment for samples not selected for retrieval.

It is known to use a cache for temporarily holding picked sample tubes as the tubes are being transferred between source racks and a destination rack. The −80° C. system described in the above incorporated patents provides such a cache in the tube picking compartment. It is important to keep the cache relatively compact in these systems because the tube picking chamber itself is small. In addition, receptacles in the cache are orientated linearly so that the receptacles in the cache can be accessed by driving the gripper along a single axis. The shuttle carrying the source or destination rack is moved perpendicularly to the linear orientation of the cache to access sample tubes locations in different rows in the tube rack. In commercial systems, the receptacles in the cache are sized to match the size of sample tubes (e.g., 8 mm diameter or 9 mm diameter) that are intended to be stored in the system. The receptacles need to be sized properly in order to hold the sample tubes vertically within the cache; otherwise the robotic tube picking mechanism cannot reliably grip and transport the sample tubes.

An object of the invention is to facilitate the robotic picking of sample tubes having different diameters, which in turn should render the storage and retrieval system more conducive to storing samples in non-uniform sample tubes or using labware from different vendors.

### SUMMARY OF THE INVENTION

The invention is an improved tube picking mechanism that is capable of robotically picking sample tubes and temporarily storing the tubes in cache when transferring the sample tubes from a source rack to a destination rack, even if the samples tubes have different sizes and diameters. The tube picking mechanism is particularly well suited for use with automated storage and retrieval systems that store samples in tubes, held in SBS tube storage racks, within an ultra-low temperature freezer (−50° C. to −90° C., e.g., −80° C.). The tube picking mechanism preferably resides in a tube picking chamber that is cooled to about −20° C. for picking and transferring tubes, and is located adjacent the −80° C. freezer compartment.

The tube picking mechanism includes a picking head that is adapted to pick and place sample tubes having a variety of diameters, and a universal cache capable of temporarily storing sample tubes having a variety of diameters in a substantially vertical orientation. Consequently, the tube picking mechanism is able to reliably grip and transport sample tubes having a variety of diameters, which in turn renders the ultra-low temperature freezer system more conducive to store racks of sample tubes having different diameters. For example, in the system described in the above incorporated patents, the tube picking feature was limited to a predesignated sample tube diameter, unless the system was physically reconfigured and in that case the tube picking feature would be limited to the reconfigured diameter. With the invention, there is no need to physically reconfigure the system to accommodate sample tubes having different diameters.

In an exemplary embodiment, the picking head and cache can be configured to pick and hold sample tubes and vials having a diameter ranging, e.g. from 8 mm to 18 mm, which is sufficient to accommodate most tubes and vials commonly used to store biological samples.

A retractable shuttle door separates the tube picking chamber from the ultra-low temperature freezer compartment. A shuttle for the tube picking mechanism moves between the tube picking chamber and the freezer compartment in order to shuttle tube racks one at a time in to the tube picking chamber and vice versa. Source racks with tubes that have been selected for extraction from the system are taken to a designated location within the freezer compartment by the freezer robot. The shuttle for the tube picking mechanism receives the source rack from the robot and transports the tube rack through the shuttle doorway into the tube picking chamber, at which time the door is closed. The shuttle preferably moves horizontally along a linear y-axis. A tube picking head located within the tube picking chamber moves horizontally along a perpendicular x-axis, and also moves vertically along a z-axis. The tube picking head has a pair of gripping jaws that are able to grip and transport a single tube after it has been lifted from a receptacle in a tube rack located on the shuttle. In order to pick a selected tube from a tube rack on the shuttle, the shuttle is indexed along the y-axis and the picking head is indexed along the x-axis. The system also preferably includes a presenter push pin located beneath the shuttle tray. The presenter push pin remains aligned with the tube picking head along a vertical z-axis. The tube picking head also includes a vertical shucker rod, which engages the top (cap) of the selected sample tube. The push pin is moved upward to engage the bottom of the selected storage tube held in the tube rack, and the sample tube is lifted from the tube rack while being held by the shucker rod from above and the push pin from below in order to provide clearance above the rack and other tubes in the rack for gripping jaws. Once the sample tube is secured in the gripping jaws, the picking head can move vertically upward to lift the tube completely clear from the rack and the other tubes in the rack, and then moved along the x-axis to set the picked tube in the cache within the tube picking chamber. Once the storage tube is set in the cache, the tube picking mechanism can then be used to pick another selected tube from the same source rack if desired. All picked tubes are transferred to the cache, at least until the cache is full. Once all of the selected storage tubes have been selected from the source rack located on the shuttle within the tube picking chamber, the shuttle door is opened and the shuttle transports the tube rack back to the designated location within the freezer compartment. The shuttle then retracts and the shuttle door closes while the freezer robot returns the source rack to its original storage location. The tube picking process repeats itself as described above until all of the selected tubes have been placed in the cache, or the cache becomes full.

Once all of the selected tubes have been placed in the cache or the cache becomes full, a “destination rack”, preferably an empty tube rack, is transported to the designated location within the freezer compartment. The destination rack is intended to be filled with storage tubes for retrieval and exit from the system through the access module. The tube picking mechanism shuttles the destination rack into the tube picking chamber and loads the storage tubes from the cache into the receptacles in the rack. The tube picking mechanism then returns the destination rack to the freezer compartment. If no more storage tubes are selected for retrieval from the system, the freezer robot will pass the destination rack to the access module for extraction from the system. If additional storage tubes are selected for retrieval, the freezer robot will move the destination rack to a holding shelf within the freezer compartment. The freezer robot and the tube picking mechanism will then again coordinate to transfer selected storage tubes from tube racks in the freezer compartment into the cache in the tube picking chamber, and consequently load the tubes from the cache into the destination rack. This process is continued until all of the tubes selected for retrieval have been loaded into the destination rack or, alternatively, the destination rack becomes full, at which time the freezer robot transports the destination rack to the access module for extraction from the system.

Use of the cache within the tube picking chamber allows for relatively fast paced shuttling of the tube racks from the freezer compartment into the tube picking chamber with the same shuttling mechanism being used for both the source racks and the destination rack. Yet, exposure time outside of the −80° C. environment is kept at a minimum for samples not selected for retrieval. In addition, it allows for the tube picking chamber to be relatively compact because it does not require room to park a destination rack within the tube picking chamber.

The tube storage racks, including source racks and destination racks, must be sized to match the sizes of tubes or vials stored in and retrieved from the system. In one aspect, the invention is directed to a method of retrieving at least one sample tube having a first diameter from the system using a destination rack configured to hold sample tubes having the first diameter, and retrieving at least one sample tube having a second different diameter from the system using a different destination rack configured to hold sample tubes having the second diameter. This is accomplished in accordance with the invention using one tube picking mechanism and one cache, each configured to accommodate tubes and vials of different sizes and diameters.

The cache in the exemplary embodiment has two parallel banks of vertical cam plates and two parallel axels. The vertical cam plates in each bank are mounted on a respective axel and are able to pivot independently of the other vertical cam plates mounted on the axel. The cam plates are weighted to fall naturally to a home position, but rotate when a sample tube exerts force against an inner edge of the respective vertical cam plate. The inner edges of the vertical cam plates on one bank of the cache are separated from the inner edges of the vertical cam plates on the other bank by an elongated space. The space provides room for the sample tubes and also the presenter push pin from below.

The inner edges of the respective vertical cam plates have an arcuate cam profile that is oriented with an upper end of the edge being spaced farther away from the opposing bank than a lower end of the edge. The vertical cam plates are mounted on the respective axel so that each plate rotates inward from the home position when a sample tube is moved downward between the respective cam plate and the opposing bank of plates such that the point of contact between the inner edge and the sidewall of the sample tube is tangential. This configuration holds the sample tube vertically, and centers the sample tube along the central plane between the banks of cam plates.

The distance between the banks of cam plates can be selected to determine the range of diameters of tubes or vials that can be stored in the cache, e.g. 8 mm to 18 mm. It is possible to make the distance between the respective parallel axels adjustable in order to change the range of diameters of tubes or vials that can be stored in the cache.

The tube picking head in the exemplary embodiment includes an actuator, a linkage connecting the actuator to the gripping jaws and springs in the linkage connecting the respective gripping jaw to the linkage. The actuator is activated to open and close the gripping jaws and springs in the linkage enable the distance between the opposing gripping jaws when closed to adjust depending on the diameter of the sample tube being held. The combination of gripping jaws capable of holding and transporting sample tubes and vials having a range of diameters, and a cache capable of temporarily holding sample tubes and vials having a range of diameters, provides significant advantage in terms of overall system flexibility and use.

It is believed that the invention resides not only in the combination of various system components as described herein, but also in the manner in which the above described components are used in order to provide the stated objects of the invention. Also, as mentioned, the invention is particularly well suited for use with the automated, ultra-low temperature storage and retrieval system disclosed in the above incorporated co-pending patent application, but certain aspects can also be used in other applications as well such as in a main freezer compartment in a −20° C. system.

The foregoing and other aspects, objects, features and advantages of the invention will be apparent to those skilled in the art from the following drawings and description of the preferred embodiment of the invention.

### BRIEF DESCRIPTION OF THE DRAWINGS

FIG. 1 is a perspective view of an automated, ultra-low temperature storage and retrieval system, including a tube picking mechanism with universal picking head and cache as constructed in accordance with an exemplary embodiment of the invention.

FIG. 2 is a view of the ultra-low temperature, automated storage and retrieval system shown in FIG. 1, with the door to the tube picking chamber removed.

FIG. 3 is a sectional view taken along line 3-3 in FIG. 2, illustrating the tube picking mechanism located within the tube picking chamber which is located adjacent the ultra-low temperature freezer compartment.

FIG. 4 is a perspective view of a tube picking mechanism constructed in accordance with an exemplary embodiment of the invention.

FIG. 5 is a front perspective view of various components of the tube picking mechanism constructed in accordance with the exemplary embodiment of the invention.

FIG. 6 is a perspective view of a portion of the exemplary tube piking mechanism, showing the universal picking head and cache, as well as a mirror to facilitate the reading of bar codes on the vertical walls of sample tubes.

FIG. 7 is an exploded assembly view of the picking head constructed in accordance the exemplary embodiment of the invention.

FIGS. 8 and 9 are perspective views illustrating the assembled the picking head.

FIGS. 10A-10C are downward looking views of the picking head showing operation of the gripping jaws to pick a sample tube from a rack or the cache.

FIG. 11 is an assembly view of an exemplary embodiment of the universal cache.

FIG. 12 is a perspective view of the exemplary embodiment of the universal cache.

FIG. 13 is schematic drawing illustrating operation of the universal cache.

FIGS. 14A-14J are a series of schematic views showing the operational steps of transferring a sample tube in the tube picking mechanism from a tube storage rack to the universal cache.

FIG. 15 is a top view showing a sample tube held vertically within the universal cache.

### DETAILED DESCRIPTION OF THE DRAWINGS

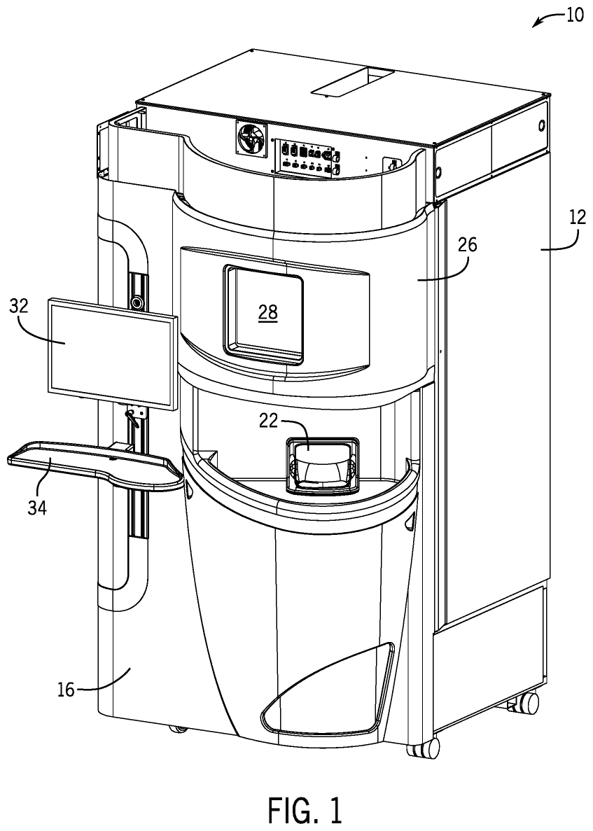

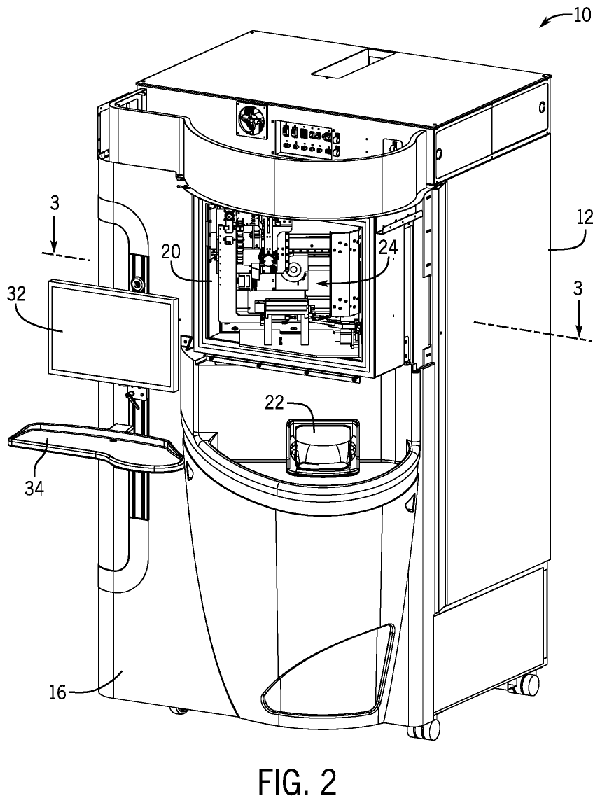

The figures illustrate various aspects of an exemplary embodiment of the invention. FIGS. 1 and 2, in particular, show an automated storage and retrieval system 10 configured to store sample storage containers such as racks for holding sealed storage tubes at ultra low temperatures (e.g. −80° C.). Overall the system 10 is similar to the system disclosed above incorporated U.S. Pat. No. 7,861,540. A tube picking mechanism 20 constructed in accordance with the present invention is particularly well suited for use with the automated, ultra-low temperature storage and retrieval system 10 shown in FIGS. 1 and 2, although various aspects of the invention can be used in connection with other systems.

The system 10, which incorporates a tube picking mechanism 20 constructed in accordance with the invention, is designed to store SBS footprint compatible tube storage racks containing tubes or vials. For example, the system 10 will be used to store tube racks containing arrays of 8 mm storage tubes, or tube racks containing arrays of 16 mm vials, or a combination of racks containing these tubes and vials of this size as well as other sizes. The system 10 generally includes an insulated freezer body 12, an internal freezer rack 18 and robot mechanism 14, a custom insulated door 16. The freezer body 12 can take the form of an upright −80° C. freezer body designed for ultra-low temperature storage for pharmaceutical, biotech, and blood bank applications.

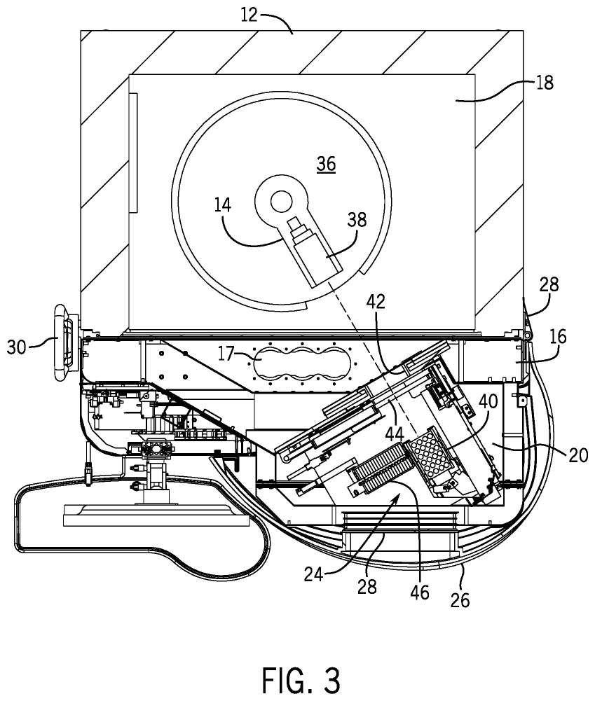

Several components are on the insulated custom door 16 in this exemplary embodiment of the invention. The door 16 includes an access module 22 in which sample storage containers, such as tube racks, are placed in order for transfer into the storage shelves on the freezer rack 18 within the freezer body 12. An electrical control and pneumatic package is also mounted to the insulated door 16 as are servomotors and magnetic couplers for driving the robot 14. Three electric motors 17 on the door 16 for driving the robot 14 within the freezer body 12 are shown in FIG. 3. The insulated door 16 also includes a tube picking chamber 24 in which a tube picking mechanism 20 resides. A decorative cover 26 is placed partially around the wall of the tube picking chamber 24. A viewing window 28 (e.g., several layers of glass) is provided through the front surface of the decorative panel 26 and the tube picking chamber 24 to allow viewing of the tube picking process. A box on the top of the freezer body 12 can house an electronic controller, power distribution electronics, battery and an inlet port from a compressed dry gas source (not shown). The insulated front door 16 is mounted to the freezer body using hinges 28, and a latch 30 as is known in the art, see FIG. 3. The system 10 includes a monitor 32 and user interface electronics. FIGS. 1 and 2 show a shelf 34 for a keyboard.

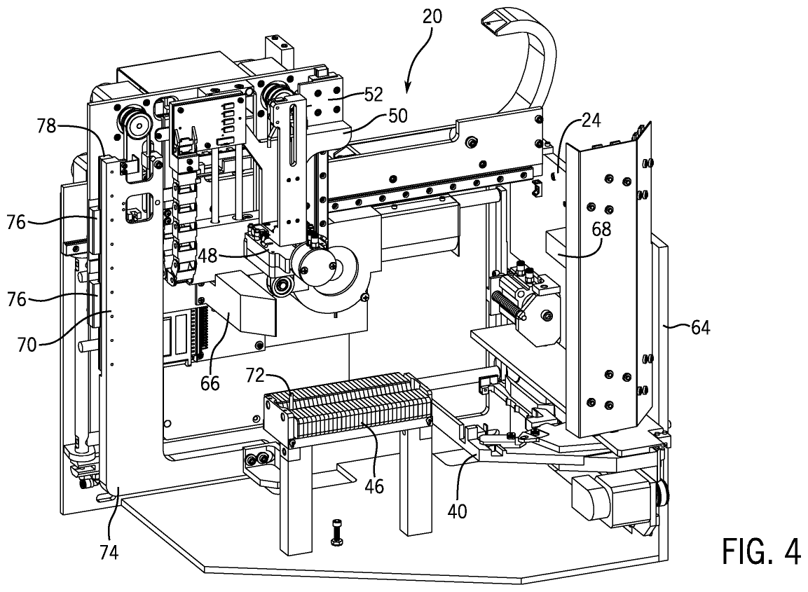

Referring now to FIG. 3, the robot 14 located within the freezer compartment 36 can be instructed to bring a tube rack containing sealed storage tubes of biological or chemical samples to a designated location 38 within the freezer compartment 36. The designated location 38 is accessible by both the robot 14 in the freezer compartment 36 and a shuttle 40 for the tube picking mechanism 20. The tube picking chamber 24 includes a doorway 42 that provides access between the tube picking chamber 24 and the freezer compartment 36 and vice versa. A sliding door 44, which is controlled by a pneumatically controlled mechanism, opens and closes to provide access. In FIG. 3, the door 44 is in the closed position. The door 44 needs to be open to shuttle tube racks in and out of the tube picking chamber 24. Within the freezer compartment 36, the system 10 will typically contain shelves for more than several hundred or more tube racks. When the system 10 is programmed to retrieve tubes from the various source racks, the source racks are fed to the designated location 38 by the robot 14 one at a time. The shuttle tray 40 for the tube picking mechanism 20 receives the chosen source rack at the designated location 38 and transports the source rack into the tube picking chamber 24, at which time the tube picking mechanism 20 picks the selected tubes from the source rack. As described in more detail below, the picked storage tubes are temporarily stored in a universal cache 46, FIG. 4, located within the tube picking chamber 24. When all the tubes have been picked from the chosen source rack, the shuttle tray 40 returns the source rack to the designated location 38 in the freezer compartment 36, and the robot 14 then returns the source rack to its home location in freezer rack 18 in the freezer compartment 36. The robot 14 then retrieves the next chosen source rack and transports it to the designated location 38. This source rack is then shuttled into the tube picking chamber 24 for tube picking as described above. The process is repeated until all the storage tubes of interest have been picked from the respective source racks by the tube picking mechanism 20, or the universal cache 46 becomes full. At that point, a destination rack, which is preferably an empty tube rack, is placed on the shuttle tray 40 by the robot 14 at the designated location 38 in the freezer compartment 36. The destination rack is then shuttled into the tube picking chamber 24 by the tube picking mechanism 20 and storage tubes are loaded from the cache 46 into the destination rack. If it is desired to extract more tubes from the system 10 or it is desired to extract tubes having different sizes and/or diameters, one or more additional source racks and the destination rack are shuttled into the tube picking chamber 24 as necessary. When the destination rack is full, or all of the selected tubes have been loaded into the destination rack, the destination rack is shuttled to the designated location 38 in the freezer compartment 36. From there, the robot 14 transports the destination rack to the access module 22 for extraction from the system.

FIGS. 4 through 6 show the internal components of a tube picking mechanism 20 constructed in accordance with the exemplary embodiment of the invention. The tube picking mechanism 20 includes a shuttle tray 40 which moves linearly along a y-axis. The door 44 must be opened in order for the shuttle 40 to move into the freezer compartment 36. The door 44 is closed in FIG. 4, and the shuttle 40 is located within the tube picking chamber 24 which is its location during a tube picking operation.

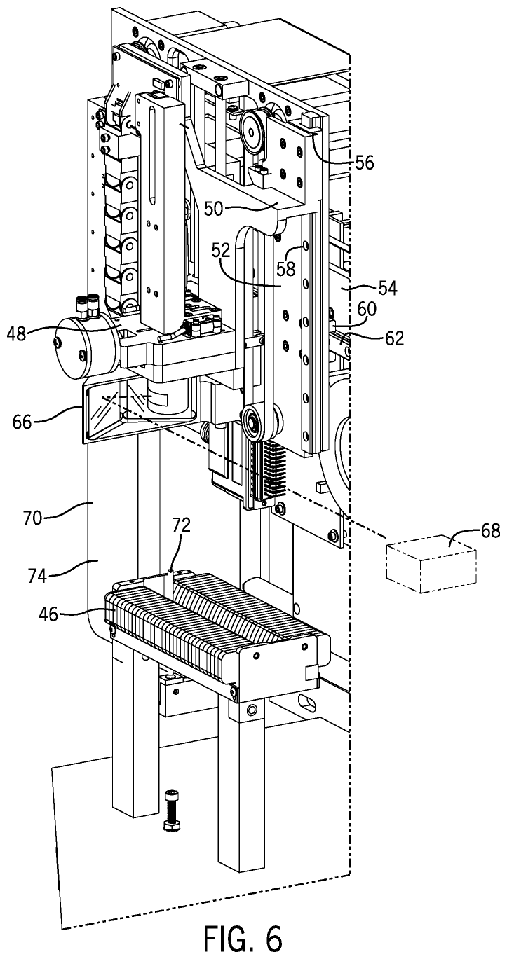

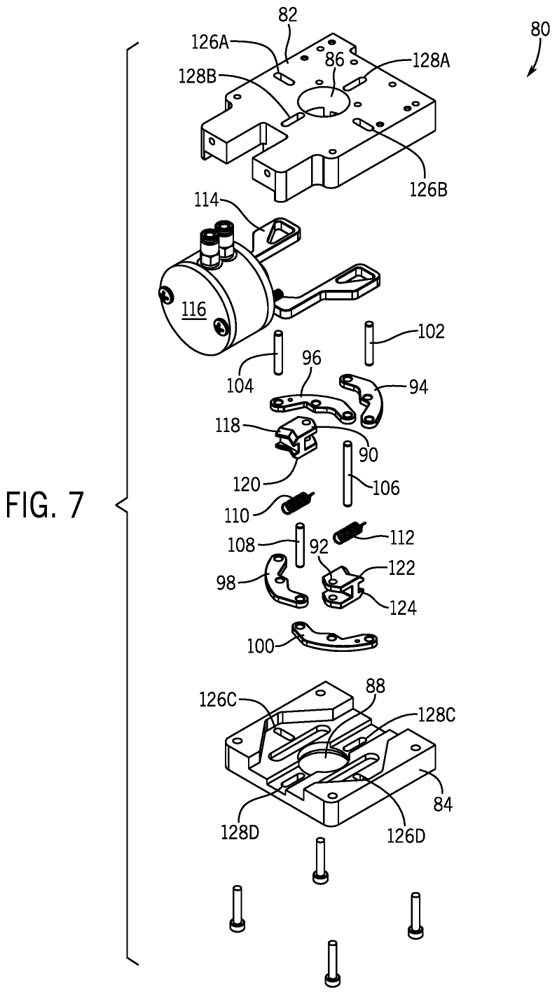

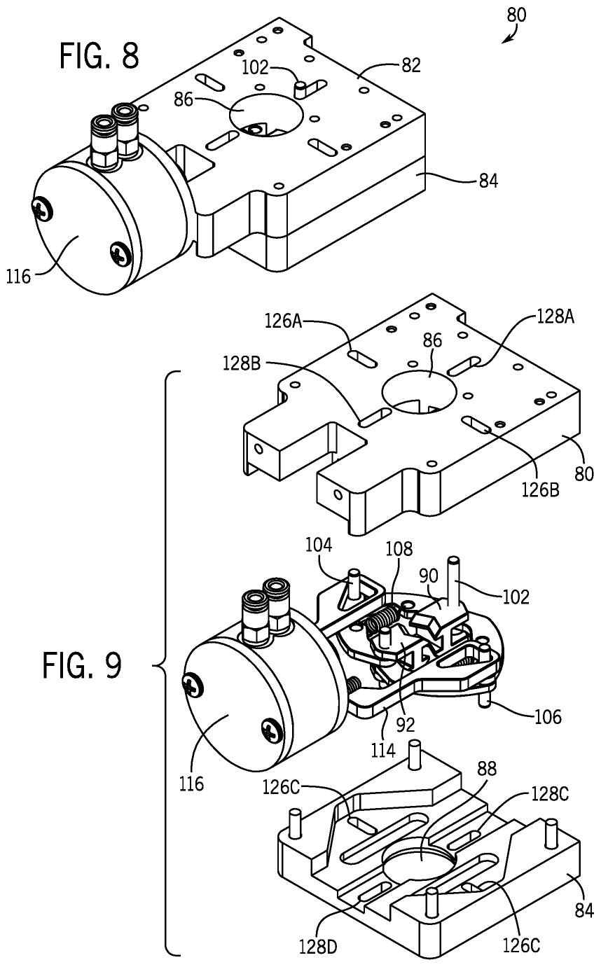

The tube picking mechanism 20 also includes a tube picking head 48 and a universal cache 46. The specific components of the tube picking head 48 are described in detail with respect to FIGS. 7-9. The tube picking head 48 is mounted to a carriage 50 and in accordance with the exemplary embodiment of the invention is configured to pick sample tubes having a variety of sizes and diameters, for example, sizes ranging from 8 mm tubes to 16 mm vials. The carriage 50 is mounted to a z-axis plate 52. The z-axis plate 52 is in turn mounted to an x-axis plate 54, such that the z-axis plate 52 is movable in an x-axis direction perpendicular to the y-axis. The carriage 50 is attached to the z-axis plate 52 with a z-axis bearing 56, see FIG. 6, that is guided for vertical movement along z-axis rail 58 on the z-axis plate 52. The carriage 50 is clamped to a belt which is driven via a stepper motor in order to move the carriage 50 and the picking head 48 vertically along the z-axis. An optical sensor can be used to sense when the z-axis bearing 56 is in the home position. The z-axis plate 52 is connected to the x-axis plate 54 with an x-axis bearing 60 for guided movement along an x-axis rail 62 on the x-axis plate 54. The z-axis plate 52 is clamped to a belt which is driven via a stepper motor in order to move the z-axis plate 52, the carriage 50 and the picking head 48 horizontally along the x-axis.

The universal cache 46 is located, in accordance with the exemplary embodiment of the invention, within the tube picking chamber 24. The purpose of the cache 46 is to temporarily store picked tubes within the tube picking chamber 24 until an appropriate time for loading the picked tubes into a destination rack for extraction from the system. The universal cache 46 is configured in the exemplary embodiment of the invention to hold tubes and vials having a variety of sizes, for example, sizes ranging from 8 mm tubes to 16 mm vials. The cache 46 is aligned linearly along the x-axis underneath the picking head 48. The x-axis underneath the picking head 48 is located at a fixed distance along the y-axis which the rack shuttle 40 moves along. Generally, to pick a tube, the shuttle 40 is indexed along the y-axis within the tube picking chamber 24 in order to align a row of tubes in the storage rack on the shuttle 40 in the appropriate y-axis position for the picking head 48. The z-axis plate 52, carriage 50 and picking head 48 are moved along the x-axis to hover over a selected storage tube in the rack on the shuttle 40. The picking head 48 then picks the selected tube from the rack on the shuttle 40. Once the selected tube is picked from the rack, the z-axis plate 52, carriage 50 and picking head 48 are moved along the x-axis to a selected position over the universal cache 46, and the picked tube is set into the cache 46.

A sidewall 64 of the picking chamber 24 includes a one dimensional barcode reader 68, such as a DC-powered reader from Keyence. The one dimensional bar code reader 68 is mounted to the wall 64 so that its field of view extends into the tube picking chamber 24 in line with the tube picking head 48 and a mirror assembly 66. The mirror assembly 66 is provided on the carriage 50 for the picking head 48 on the side opposite the barcode code reader. As shown in FIG. 6, the mirror assembly 66 includes two mirrors, e.g., intersecting at an approximate 120 degree angle along the centerline of the picking head 48. When a sample tube is held in the picking head 48, the bar code reader 68 is able to view the side of the sample tube facing the bar code reader, and is also able to view each of the angled mirrors. With this configuration, the bar code reader 68 is able to read a bar code applied to the sidewall of a sample tube held in the picking head 48, whether the bar code is facing the bar code reader or one of the mirrors in the mirror assembly 66.

The z-axis plate 52 includes not only a vertical drive for the carriage 50 and picking head 48, but also a vertical drive for a presenter push pin assembly 70. The presenter push pin assembly 70 includes a vertical presenter push pin 72 that moves with the z-axis plate 52 such that it remains aligned along the z-axis of the picking head 48, and is configured to move up and down along the z-axis below the shuttle 40 and the universal cache 46. The presenter push pin 72 is mounted via a mounting bracket attached to the end of an L-shaped presenter arm 74. The presenter arm 74 has a vertical rail 78 that is mounted via linear bearings 76 on the z-axis plate 52. A stepper motor mounted to the z-axis plate 52 drives a pulley and belt, and the presenter arm 74 is clamped to the belt such that operation of the stepper motor causes the presenter push pin 72 to move upward or downward along the z-axis for the picking head 48. Note that the motion of the presenter arm 74 and pin 72 along the z-axis can be independent of the z-axis motion for the picking head 48.

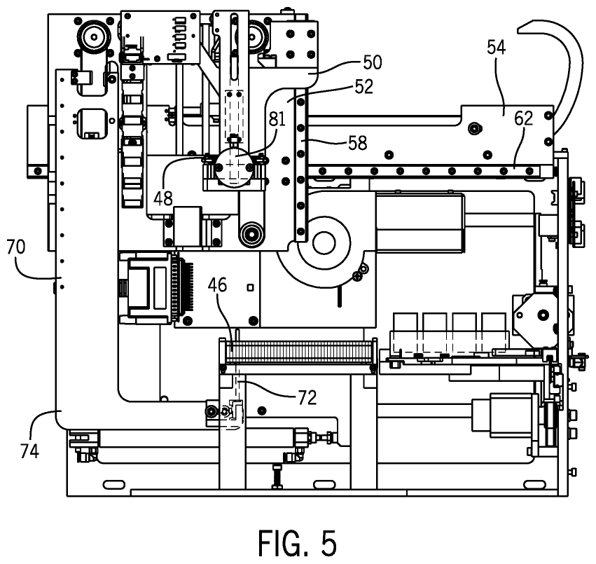

Referring to FIG. 5 in particular, the picking head 48 includes a shucker rod 81 (shown in phantom) which moves vertically up and down to facilitate picking of tubes and vials by the picking head 48 and to facilitate removal of a picked tubes and vials from the picking head 48. The operation of the shucker rod 81 is controlled, preferably, with a high resolution linear motor. The shucker rod 81 can be positioned intermediately between a fully retracted position and a fully extended position.

FIGS. 7-9 show the construction of the tube gripping mechanism 80 of the picking head 48. The tube gripping mechanism 80 includes two gripping jaws 90, 92 that are configured to grip the sidewall of a sample tube or vial being picked. Each gripping jaw 90, 92 has an upper V-shaped gripping pad 118, 122 and a lower V-shaped gripping pad 120, 124. The respective upper V-shaped gripping pad 118, 122 and lower V-shaped gripping pad 120, 124 are configured to hold the tube or vial vertically when held by the tube gripping mechanism 80. The upper gripping pads 118, 122 are chamfered to help guide the shucker rod 81 between the gripping jaws 90, 92 when it is moved downward through the gripping mechanism 80. The lower gripping pads 120, 124 are chamfered to help guide the presenter pin 72 between the gripping jaws 90, 92 when it is moved upward through the gripping mechanism 80. A pneumatic actuator 116 is activated to open and close the gripping jaws 90, 92 via a spring-loaded linkage mechanism. A u-bracket 114 is driven be the actuator 114 between an open position and a closed position. Linkage arms 94, 96, 98, 100, linkage rods 102, 104, 106, 108 and springs 110, 112 form the spring-loaded mechanism which moves the gripping jaws 90, 92 between the open position and the closed position. The springs 110, 112 stretch when the gripping jaws 90, 92 are closed around a sample tube thereby enabling the tube gripping mechanism 80 to hold tubes and vials having a variety of diameters.

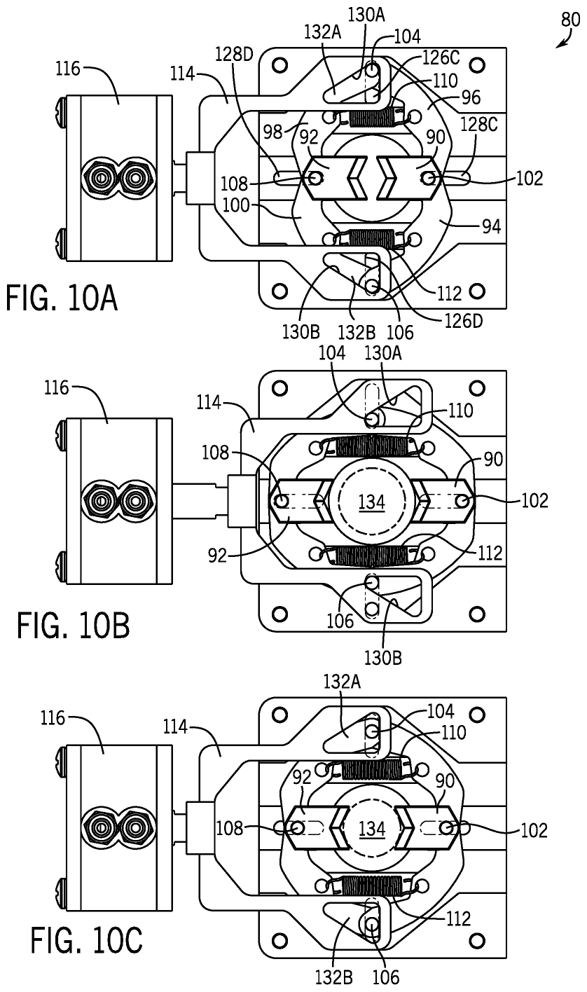

The tube gripping mechanism 80 has an upper plate 82 and a lower plate 84, which house the components of the spring loaded linkage mechanism. The upper plate 82 has a central opening 86, and the lower plate 84 also has a central opening 88, which is aligned with the central opening 86 on the upper plate 82 when the mechanism 80 is assembled. The plates 82, 84 include slotted openings 126A, 126B, 126C, 126D and 128A, 128B, 128C, 128D for guiding the motion of linkage rods 102, 104, 106 and 108, which in turn moves the ends of the linkage arms 94, 96, 98 and 100 to position the gripping jaws 90, 92 in response to the activation of the pneumatic actuator 116 and the shifting of the u-bracket 114. Referring to FIGS. 10A through 10C, FIG. 10A shows an empty tube gripping mechanism 80 in a fully closed position, FIG. 10B shows the tube gripping mechanism in a fully open position preparing to hold a sample tube 134, and FIG. 10C shows the tube gripping mechanism in a closed position with a sample tube 134 held by the gripping jaws 90, 92. In FIG. 10A, the u-bracket 114 is in a retracted or closed position, such that the linkage rods 104, 106 are positioned at the outer end of the respective slots 126C and 126D. The springs 110, 112 are connected between linkage arms 96, 98 and 94, 100 respectively, and pull the linkage arms as well as linkage rods 102, 108 and gripping jaws 90, 92 together to the fully closed position.

Each side of the u-bracket 114 includes a triangular opening 130A, 130B, each having an angular cam surface 130A, 130B. When the actuator 116 is activated to extend the u-bracket 114 as shown in FIG. 10B, the respective angular cam surface 130A, 130B moves the linkage rods 104, 106 inward within the respective slot 126C, 126D, which in turn pushes the ends of the linkage arms connected to the rods 104, 106 inward. This has the effect of pushing the rods 102, 108 in slots 128C, 128D and the gripping jaws 90, 92 outward against the force of the springs. At this point, a sample tube 134 can be placed between the gripping jaws 90, 92 as shown in FIG. 10B. Then, as shown in FIG. 10C, the actuator 116 is activated to retract the u-bracket 114, which in turn allows the springs 110, 112 to pull the gripping jaws 90, 92 together against the sidewall of the sample tube 134. Because the sample tube 134 is between the gripping jaws 90, 92, the rods 104, 106 do not slide to the outer ends of their respective slots 104, 106, see FIG. 10C. Accordingly, the tube gripping mechanism 80 is capable of holding tubes and vials having a wide variety of diameters.

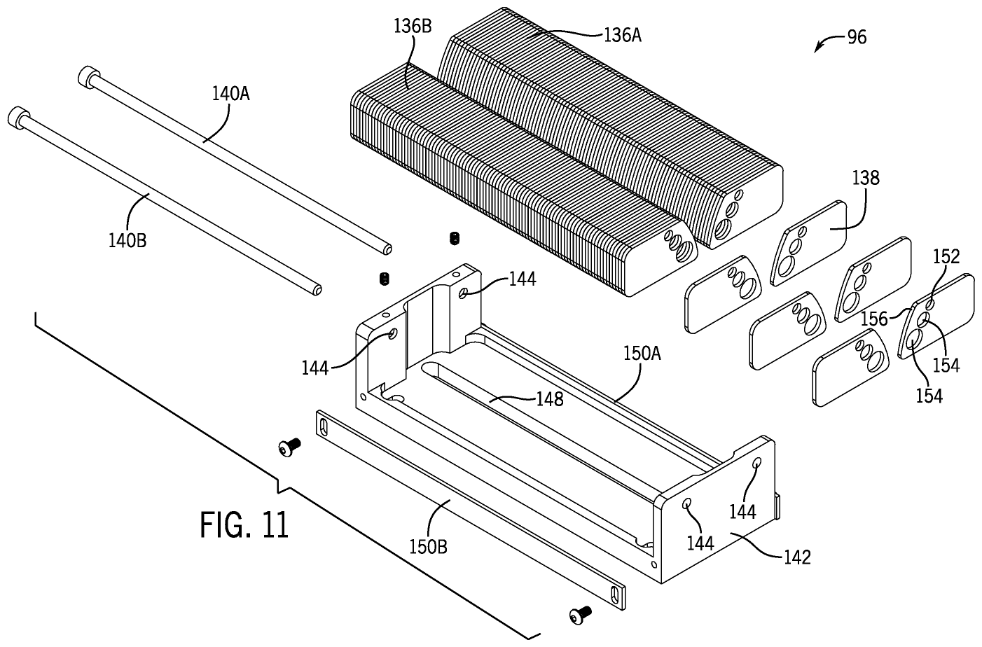

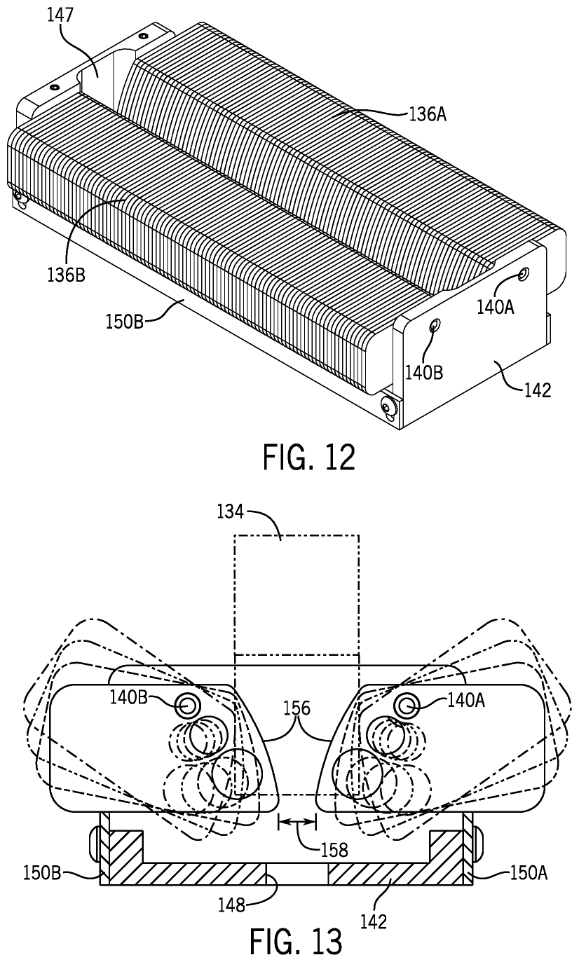

The components of a universal cache 46, constructed in accordance with the exemplary embodiment of the invention, are shown unassembled in FIG. 11 and assembled in FIG. 12. The cache 46 has two parallel banks 136A, 136B of vertical cam plates 138 mounted on two parallel axels 140A, 140B. The axels 140A, 140B are mounted through mounting holes 144 in sidewalls 146A, 146B of the cache base 142. Set screws 145 hold the axels 140A, 140B in place on the cache base 142. A longitudinal slot 148 is located through the floor of the base 142 between the banks 136A, 136B of vertical cam plates 138. The vertical cam plates 138 in each bank 136A, 136B are mounted on the respective axel 140A, 140B and are free to pivot independently of the other vertical cam plates 138 mounted on the axel. The cam plates 138 sit naturally in a home position as shown in FIG. 12. A longitudinal homing plate 150A, 150B is located on each side of the cache base 142, and serves to stop the rotation of the cam plates 138 in the respective home position when the cache 46 is empty. In the exemplary embodiment, the length of the parallel banks 136A, 136B of vertical cam plates 136 is sufficient to hold 12 tubes or vials spaced at 9 mm center to center spacing, e.g., a total length of 142 mm. A small distance can be provided between the end wall of the base and the cam plate 138 adjacent the end wall as shown by reference number 147 in FIG. 12. As long as some cam plates 138 remain beyond the center line of the tube or vial when the space 147 is used, the tube or vial will remain vertical in the cache 46.

Each vertical cam plate 138 has a center of mass offset from the respective axel 140A, 140B such that the plate rotates towards the home position unless a sample tube is placed in the cache 46 between the banks 136A, 136B. In the embodiment shown, there are three holes in each vertical cam plate 138, namely hole 152 which is used to mount the cam plate on the respective axel 140A, 140B and holes 154 which are included to lighten the respective side of the cam 138 and shift the center of mass so that it naturally rotates to the home position. The longitudinal homing plates 150A, 150B for each bank 136A, 136B stops the rotation of the respective vertical cam plates in the home position.

Referring to FIGS. 13 and 15, the inner edges 156 of the vertical cam plates 138 on one bank 136A of the cache 46 are separated from the inner edges 156 of the vertical cam plates 138 on the other bank 136B by an elongated space 158. The inner edges 156 of the respective vertical cam plates 138 have an arcuate cam profile that is oriented with an upper end of the edge 156 being spaced farther away from the opposing bank than a lower end of the edge. In the embodiment shown in the drawings, the arcuate edge 156 has constant 40 mm radius. When a sample tube 134 is placed downward into the cache 46, the respective cam plates 138 rotate from the home position as the sample tube exerts force against an inner edge 156 of the respective vertical cam plate 138. The vertical cam plates 138 are mounted on the respective axel 140A, 140B and rotate inward from the home position when a sample tube 134 is inserted such that the point of contact between the respective inner edge 156 and the sidewall of the sample tube 134 is tangential. The weight of the respective cam plates 138 causes the inserted sample tube to self-center between the banks 136A, 136B of cam plates. It is also noted that the cam plates 138 positioned at a location corresponding to the full diameter of the inserted sample tube 134 rotate farther away from the home position than the cam plates located at a position corresponding to an edge of the inserted sample tube 134. The cache 46 also reliably maintains the inserted sample tube oriented in a vertical direction. The thickness of the cam plates 138 should be selected to provide an appropriate resolution for holding tubes and vials having the diameters expected, while at the same time providing sufficient weight so that the cam plates rotate independently. In the shown embodiment, the cam plates are made of steel having a thickness of about 0.060 of an inch. This thickness is suitable to provide an appropriate resolution for holding tubes and vials having diameters ranging from 8 mm to 18 mm, while at the same time providing sufficient weight to overcome ancillary frictional forces that might otherwise impede the independent rotation of the cam plates on the respective axels. Spacers can be placed between the adjacent cam plates and/or the sidewalls of the base in order to prevent sticking if necessary.

It can be seen that cache 46 is capable of accepting and holding tubes and vials having a variety of diameters. For small tubes having a diameter of 8 mm it is desirable that the distance 158 between the arcuate inner edges 156 of opposing cam plates 138 be approximately 5 mm. This ensures that a sufficient number of cam plates 138 are displaced and rotate when the tubes are inserted. It is possible to adjust the distance 158 in the embodiment of the cache 46 shown in the drawings, e.g. in case the range of diameters of the tubes or vials expected to be stored in the cache 46 needs to be accommodated. The distance 158 is adjusted by changing the height of the respective homing plates 150A, 150B on the cache base 142, which in turn changes the rotational orientation of the cam plates 138 when they are in the home position, but also changes the distance 158. In practice, the adjustment can be done by providing a fixture with a calibrated rib through the slot 148 and between the inner edges 156 of the cam plates 138. Then, the height of the longitudinal homing plates 150A, 150B is set to the appropriate height to support the cam plates 138 defined by the calibrated rib.

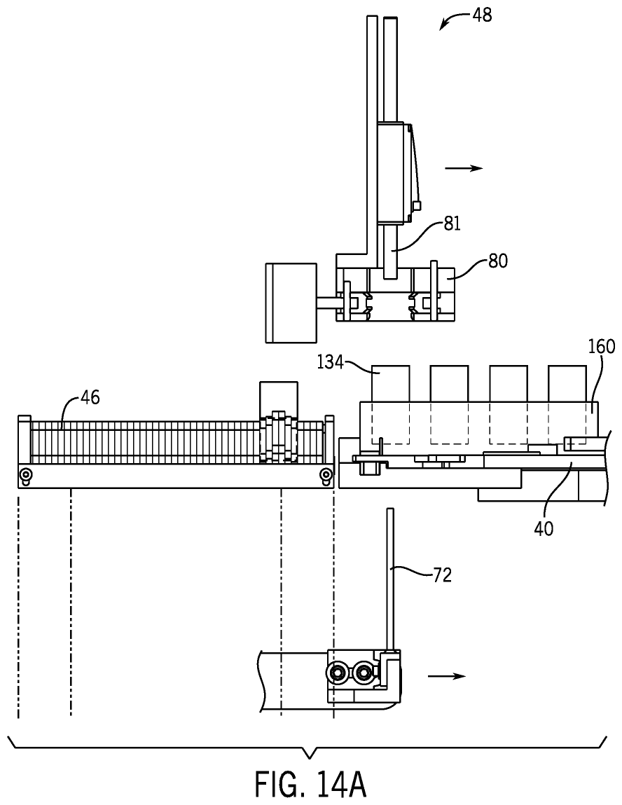

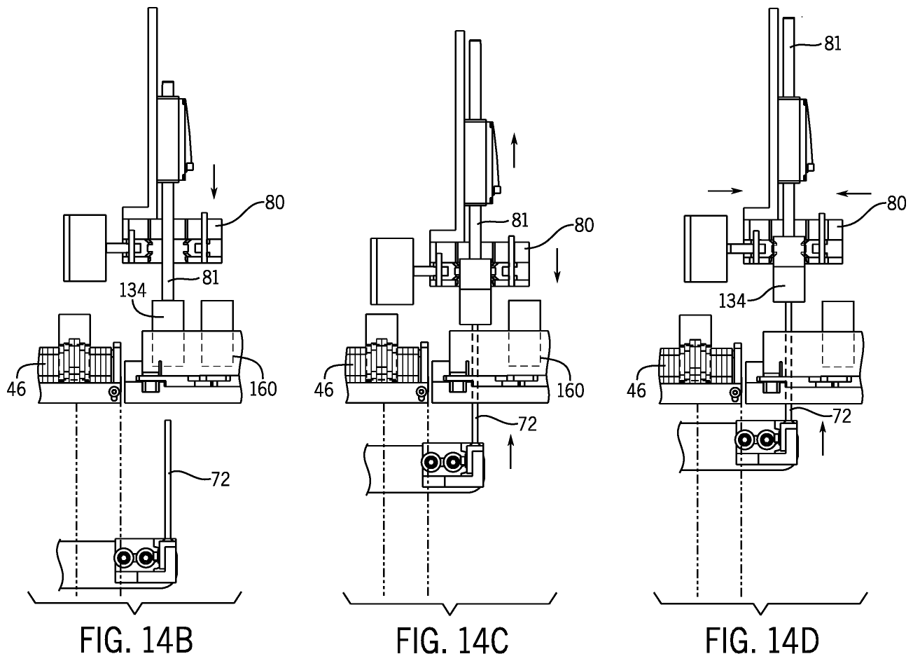

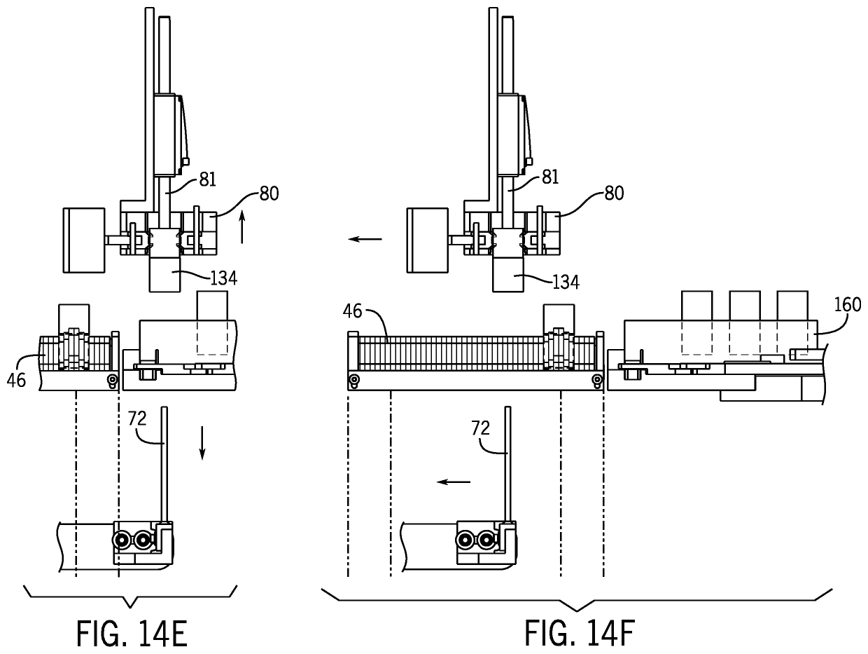

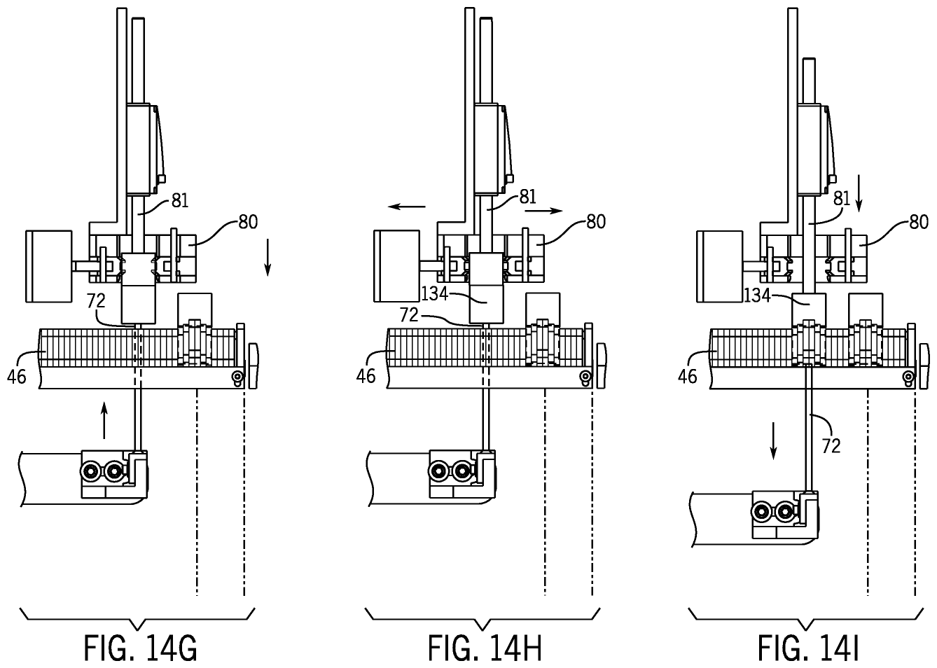

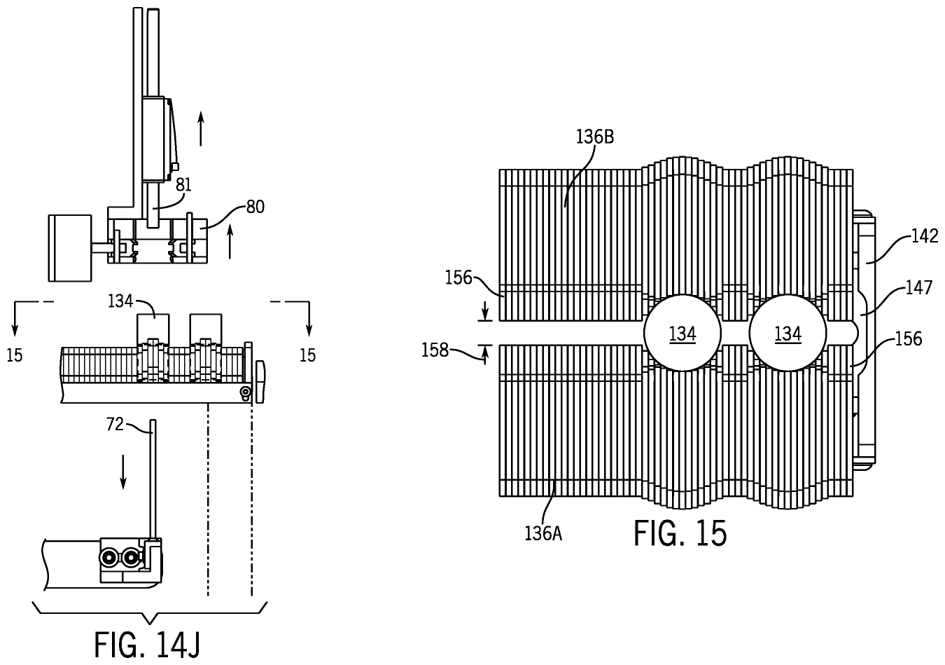

FIGS. 14A-14J are a series of schematic views showing the operational steps of transferring a sample tube 134 from a tube storage rack 160 in the shuttle tray 40 to the universal cache 46. In FIG. 14A, the picking head 48 and the presenter push pin 72 are aligned over a sample tube 134 in a storage rack 160 located on the shuttle tray 40 in the tube picking chamber. The shucker rod 81 is in a retracted position, and so is the presenter push pin 72. FIG. 14B shows the shucker rod 80 in an extended position against the top surface of the sample tube 134. The position of the shucker rod 81 relative to the picking head 80 is controlled using a high resolution linear motor. The control system is programmed with the height dimensions of the sample tube 134 and controls the height of the picking head 48 as well as the linear motor to control the height of the shucker rod 81. FIG. 14C shows the presenter push pin 72 after it has been raised against the bottom of the sample tube 134, and then with downward pressure on the top of the sample tube 134 (cap) from rod 81 and upward pressure on the bottom of the sample tube 134 from the pin 72, raised to lift the tube 134 from the tube storage rack 160. In step 14C, the rod 80 is retracted with the rod 80 and the pin 72 maintaining positive pressure on the top and bottom of the sample tube 34, respectively. This movement places the sample tube between the gripping jaws 90, 92 of the tube gripping mechanism 80, see FIG. 10B. FIG. 14D shows the gripping jaws 90, 92 closing around the sample tube 134, see FIG. 10C. FIG. 14E shows the pin 72 after it is retracted downward. The tube gripping mechanism 80 remains at a height sufficient to ensure that the sample tube 134 clears the rack and other tubes in the rack 160 completely before transporting the sample tube to the cache 46. In FIG. 14F, the picking head 48 and the presenter push pin 72 have been repositioned over the cache 46 with the sample tube 134. The presenter push pin 72 is in a retracted position, and the picking head 48 continues to be in a fully lifted position. FIG. 14G shows the picking head 48 being lowered so that the sample tube 34 hovers over the cache 46, and in particular at a selected location over the space between the banks of cam plates in the cache. The presenter push pin 72 is raised through the slot in the base of the cache and between the banks of cam plates until it engages the bottom of the sample tube 134. FIG. 14H shows the gripping jaws 90, 92 releasing the sample tube 134 while the rod 81 maintains pressure on the top of the tube 134 and the pin 72 maintains pressure on the bottom of the tube 134. FIG. 14I shows the rod 81 being extended to move the sample tube 134 downward into the cache 46, causing the relevant cam plates to rotate. After the sample tube is in place in the cache 46, the pin 72 is retracted and the rod 81 is lifted, see FIG. 14J. The height of the tubes 134 in the cache 46 is stored in the controller. This process is repeated to transfer subsequent sample tubes from source racks on the shuttle to the cache. When all of the desired sample tubes have been placed in the cache, a destination rack is placed on the shuttle tray and the sample tubes in the cache 46 are transported to the destination rack, using a similar process as described in FIGS. 14A-14J to transport the tubes or vials.

The exemplary embodiment of the invention has been described herein with respect to use with an ultra-low temperature (−80° C.), automatic storage and retrieval system. However, many of the features described herein may be useful in storage systems that store samples at freezing temperatures above or below the ultra-low temperature range. Those skilled in the art should appreciate that these features, among others, while useful in connection with tube picking mechanisms located in a tube picking chamber adjacent an ultra-low temperature (−80° C.) freezer compartment, are also useful in other applications as well. For example, the tube picking mechanism can be used in applications outside of or not including a cold chamber.

We claim:

1. An automated, ultra-low temperature sample storage and retrieval system comprising:
a freezer body having an ultra-low temperature, insulated compartment that is maintained at an ultra-low temperature from about −50° C. to −90° C. under normal operating conditions when biological or chemical samples are being stored in the ultra-low temperature compartment;
at least one freezer rack having trays for storing sample storage containers holding biological or chemical samples, wherein at least some of the sample storage containers are tube racks which hold sealed sample tubes containing biological or chemical samples;
a robot located within the ultra-low temperature freezer compartment for transporting storage sample containers within the freezer compartment;
an access module for introducing sample storage containers into the ultra-low temperature freezer compartment and for retrieving storage containers from the ultra-low temperature freezer compartment; and
a tube picking mechanism located within a tube picking chamber, there being a shuttle door which provides access when open between the tube picking chamber and the ultra-low temperature storage compartment within the freezer, the tube picking mechanism comprising:
a shuttle for moving tube storage racks through the shuttle door from the ultra-low temperature freezer compartment into the tube picking chamber and vice versa;
a tube picking head having a pair of opposing gripping jaws configured to hold a sample tube by griping a sidewall of the sample tube when the gripping jaws are closed, wherein the distance between the opposing gripping jaws when closed is adjustable depending on the diameter of the sample tube being held; and
a cache having two parallel banks of vertical cam plates and two parallel axels, wherein the vertical cam plates in each bank are mounted on a respective axel and able to pivot independently of the other vertical cam plates mounted on the axel from a home position when a sample tube exerts force against an inner edge of the respective vertical cam plate.

2. The system recited in claim 1 wherein the inner edges of the vertical cam plates on one bank of the cache are separated from the inner edges of the vertical cam plates on the other bank by an elongated space.

3. The system recited in claim 2 wherein the inner edges of the respective vertical cam plates have an arcuate cam profile that is oriented with an upper end of the edge being spaced farther away from the opposing bank than a lower end of the edge, and the respective vertical cam plate is mounted on the respective axel so that the plate rotates inward from the home position when a sample tube is moved downward between the respective cam plate and the opposing bank of plates such that a point of contact between the inner edge and the sidewall of the sample tube is tangential.

4. The system recited in claim 2 wherein the distance between the respective parallel axels is adjustable.

5. The system recited in claim 1 wherein each vertical cam plate has a center of mass offset from the respective axel such that the plate rotates towards the home position as the sample tube is withdrawn upward from the cache, and the cache includes a guide member for each bank which stops the rotation of the respective vertical cam plates in the home position.

6. The system recited in claim 1 wherein the tube picking head includes an actuator, a linkage connecting the actuator to the gripping jaws and springs in the linkage connecting the respective gripping jaw to the linkage, wherein the actuator is activated to open and close the gripping jaws and springs in the linkage enable the distance between the opposing gripping jaws when closed to adjust depending on the diameter of the sample tube being held.

7. The system recited in claim 1 wherein the tube picking mechanism further comprises:
a presenter push pin that is oriented vertically and can be moved in a horizontal direction and a vertical direction, wherein the presenter push pin is able to be located below the shuttle when it is located within the tube picking chamber and move upward to contact a bottom wall of a sample tube in a tube rack on the shuttle and the presenter push pin is able to be located below the cache a move upward through an elongated slot in a base of the cache to the push a sample tube temporarily upward from the elongated space in the cache between the parallel banks of vertical cam plates.

8. The system as recited in claim 7 wherein the gripping head also includes a vertical shucker rod that moves vertically in alignment with the presenter push pin in order to press downward on the cap of the sample tube while the presenter push pin pushes upward on the bottom of the sample tube in order to hold the sample tube and raise the sample tube from a tube rack in the shuttle or the cache so that the gripping jaws are able to close against the sidewalls of the tube to hold the tube and move the tube, and in order to hold the sample tube to allow the gripping jaws to release and lower the tube in to a receptacle in a tube rack on the shuttle or into the cache.

9. The system recited in claim 1 wherein each gripping jaw includes two levels of v-grooved jaws which are aligned vertically so that a sample tube held in the gripping head is held vertically.

10. The system recited in claim 1 further comprising a y-axis linear drive mechanism located within the tube picking chamber which is mounted to the frame of the tube picking mechanism and moves the shuttle horizontally along a y-axis such that the shuttle resides within the −80° C. freezer compartment when the y-axis linear drive mechanism is fully extended and resides within the tube picking chamber when the y-axis linear drive mechanism is fully retracted.

11. The system recited in claim 8 further comprising
a one-dimensional bar code reader for identifying and reading a bar code on a sidewall of a sample tube picked and lifted by the shucking piston and the presenter push pin, and a mirror located in the tube picking chamber such that the picked and lifted sample tube can be located between the one-dimensional bar code reader and the mirror.

12. In an automated, sample storage and retrieval system having trays for tube racks holding biological or chemical samples in sample tubes, a method of retrieving sample tubes from the system comprising the steps of:
providing a tube picking mechanism located in a tube picking chamber for picking sample tubes one at a time from one or more source tube racks stored in the system and placing the picked samples tubes in one or more destination racks for retrieval from the system, wherein the tube picking mechanism is capable of picking a sample tube from a tube rack for a variety of sample tubes having a range of diameters;
providing a cache that is capable of temporarily storing sample tubes having a range of diameters vertically in the tube picking chamber;
shuttling a first source rack into the tube picking chamber, wherein the first source rack contains sample tubes having a first diameter;
picking at least one sample tube from the first source rack shuttled into the tube picking chamber;
placing the at least one sample tube having a first diameter that was picked from the first source rack with the tube picking mechanism into the cache to temporary hold the sample tube vertically within the tube picking chamber;
shuttling the first source rack from the tube picking chamber after the at least one sample tube has been picked from the first source rack and placed in the cache;
providing a first destination rack intended to be removed from the system through the access module, wherein the first destination rack is configured to hold sample tubes having the first diameter;
shuttling the first destination rack into the tube picking chamber and loading the at least one sample tube having the first diameter with the tube picking mechanism from the cache into the first destination rack;
shuttling the first destination rack containing the at least one sample tube having a first diameter from the tube picking chamber;
removing the first destination rack from the system through the access module in order to retrieve the at least one sample tube having a first diameter;
shuttling a second source rack into the tube picking chamber, wherein the second source rack contains sample tubes having a second diameter, which is different from the first diameter;
picking at least one sample tube from the second source rack shuttled into the tube picking chamber;
placing the at least one sample tube having a second diameter that was picked from the second source rack with the tube picking mechanism into the cache to temporary hold the sample tube vertically within the tube picking chamber;
shuttling the second source rack from the tube picking chamber after the at least one sample tube has been picked from the second source rack and placed in the cache;
providing a second destination rack intended to be removed from the system through the access module, wherein the second destination rack is configured to hold sample tubes having the second diameter;
shuttling the second destination rack into the tube picking chamber and loading the at least one sample tube having the second diameter with the tube picking mechanism from the cache into the second destination rack;
shuttling the second destination rack containing the at least one sample tube having the second diameter from the tube picking chamber;
removing the second destination rack from the system through the access module in order to retrieve the at least one sample tube having the second diameter;

13. The method recited in claim 12 wherein the automated, sample storage and retrieval system includes a freezer compartment maintained at an ultra-low temperature between −50° C. and −90° C. and a shuttle door located between the tube picking chamber and the freezer compartment

14. The method recited in claim 12 wherein the first or second destination rack is shuttled into the tube picking chamber to load selected storage tubes from the cache several times prior to removing the respective destination rack from the system through the access module.

15. The method recited in claim 12 wherein the tube picking mechanism includes a gripping jaw, a shucker rod and a presenter push pin, and the steps of picking a sample tube from a rack or the cache requires that the shucker rod engage the top of the respective sample tube and the presenter push pin engage the bottom of the sample tube, and that the respective sample tube be lifted vertically from the rack or cache to provide clearance for the gripping jaw to grip the sidewall of the picked tube, and further that the presenter push pin releases downward to clear the rack or cache prior to transporting the picked sample tube to another location.

16. The method recited in claim 12 wherein the cache comprises: a cache having two parallel banks of vertical cam plates and two parallel axels, wherein the vertical cam plates in each bank are mounted on a respective axel and able to pivot independently of the other vertical cam plates mounted on the axel from a home position when a sample tube exerts force against an inner edge of the respective vertical cam plate.

17. The method recited in claim 16 wherein the inner edges of the respective vertical cam plates have an arcuate cam profile that is oriented with an upper end of the edge being spaced farther away from the opposing bank than a lower end of the edge, and the respective vertical cam plate is mounted on the respective axel so that the plate rotates inward from the home position when a sample tube is moved downward between the respective cam plate and the opposing bank of plates such that a point of contact between the inner edge and the sidewall of the sample tube is tangential.

18. The method recited in claim 15 wherein the tube picking mechanism further includes an actuator, a linkage connecting the actuator to the gripping jaws and springs in the linkage connecting the respective gripping jaw to the linkage, wherein the actuator is activated to open and close the gripping jaws and springs in the linkage enable the distance between the opposing gripping jaws when closed to adjust depending on the diameter of the sample tube being held.

19. The method recited in claim 15 wherein the presenter push pin is oriented vertically and can be moved in a horizontal direction and a vertical direction, wherein the presenter push pin is able to be located below the shuttle when it is located within the tube picking chamber and move upward to contact a bottom wall of a sample tube in a tube rack on the shuttle and the presenter push pin is able to be located below the cache and move upward through an elongated slot in a base of the cache to push a sample tube upward from the elongated space in the cache between the parallel banks of vertical cam plates.

20. A tube picking mechanism comprising:
a shuttle for moving tube storage racks;
a tube picking head having a pair of opposing gripping jaws configured to hold a sample tube by griping a sidewall of the sample tube when the gripping jaws are closed, wherein the distance between the opposing gripping jaws when closed is adjustable depending on the diameter of the sample tube being held; and
a cache having two parallel banks of vertical cam plates and two parallel axels, wherein the vertical cam plates in each bank are mounted on a respective axel and able to pivot independently of the other vertical cam plates mounted on the axel from a home position when a sample tube exerts force against an inner edge of the respective vertical cam plate.
